(19) United States
(12) Patent Application Publication
(10) Pub. No.: US 2017/0052756 A1
(43) Pub. Date: Feb. 23, 2017

(54) Method and Apparatus for Image Capture in Transmitter of Wireless Communications System

(71) Applicant: MediaTek Inc., Hsin-Chu (TW)

(72) Inventors: Ming-Chih LUNG, Tainan City (TW); Wei-Kai LIAO, New Taipei City (TW)

(21) Appl. No.: 15/340,892

(22) Filed: Nov. 1, 2016

Related U.S. Application Data
(63) Continuation of application No. 13/787,829, filed on Mar. 7, 2013.
(60) Provisional application No. 61/748,450, filed on Jan. 3, 2013.

(51) Int. Cl. G06F 3/14; G09G 5/39

(52) U.S. Cl. CPC G06F 3/1454; G09G 5/39; G09G 2370/16; G09G 2360/127

(57) ABSTRACT

A method for capturing an image in a transmitter of a wireless communications system, the method comprising controlling a graphic processing unit (GPU) of a graphic card to move frames corresponding to the image from a graphic card frame buffer to a buffer which is accessible by a central processing unit (CPU) of the transmitter when a specified condition is detected; controlling the GPU to release a control for the frames to the CPU; encoding the frames in the buffer which is accessible by the CPU; and transmitting the encoded frames to a receiver of the wireless communications system; wherein the graphic card is connected to the transmitter.

### CROSS REFERENCE TO RELATED APPLICATIONS

This application is a Continuation of U.S. application Ser. No. 13/787,829 filed on Mar. 7, 2013, which claims the benefit of U.S. Provisional Application No. 61/748,450, filed on Jan. 3, 2013, entitled “Miracast screen capture system and method, using High Level Shader Language and Direct X11”, the contents of which are incorporated herein in their entirety.

### BACKGROUND

The present invention relates to a method and apparatus utilized in a wireless communications system, and more particularly, to a method and apparatus of capturing an image in a transmitter in a wireless communication system.

Wireless Fidelity (Wi-Fi) Display specification is a standard for a Wi-Fi technology and used in a latency-aware application for streaming in a short distance. In the Wi-Fi Display application, a connection is established between a source device and a sink device. The source device encodes video contents into encoded video bit streams and sends the encoded video bit streams to the sink device. The sink device further decodes the received video bit streams and recovers to the video contents. Therefore, a user can watch the video contents via a suitable display of the sink device for the user's purpose than a display of the source device. For example, a user shares a video from a notebook computer to a large screen television so that people can comfortably watch the video on the television together. In this scenario, the notebook computer is the source device and the television is the sink device (assuming the television supports Wi-Fi Display specifications), and the source device transmits video contents to the sink device for playback on a display of the sink device.

In order to encode video contents into encoded video bit streams and send the encoded video bit streams to the sink device, the source device should use an external graphic card to capture the video content and perform the relevant operations. Besides, the source device duplicates the encoded video bit streams to show the video contents in the source device and the sink device simultaneously.

Therefore, how to accurately perform the abovementioned operations in the source device and further speed up the display in the sink device is a goal in the industry.

### SUMMARY

The present invention therefore provides a method and apparatus for capturing an image in a transmitter of a wireless communications system, to enhance display performance in a receiver of the wireless communications system.

A method for capturing an image in a transmitter of a wireless communications system is disclosed. The method comprises controlling a graphic processing unit (GPU) of a graphic card to move frames corresponding to the image from a graphic card frame buffer to a buffer which is accessible by a central processing unit (CPU) of the transmitter when a specified condition is detected; controlling the GPU to release a control for the frames to the CPU; encoding the frames in the buffer which is accessible by the CPU; and transmitting the encoded frames to a receiver of the wireless communications system; wherein the graphic card is connected to the transmitter.

A communication apparatus for a wireless communications system is disclosed. The communication apparatus comprises a processing means; a storage unit; and a program code, stored in the storage unit, wherein the program code instructs the processing means to execute the following steps: controlling a graphic processing unit (GPU) of a graphic card to move frames corresponding to the image from a graphic card frame buffer to a buffer which is accessible by the processing means when a specified condition is detected; controlling the GPU to release a control for the frames to the processing means; controlling an encoding unit to encode the frames in the buffer which is accessible by the processing means; and controlling a communication interfacing module to transmit the encoded frames to a receiver of the wireless communications system; wherein the graphic card is connected to the communication apparatus.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system according to an example of the present invention.

FIG. 2 is a flowchart of a process according to an example of the present invention.

### DETAILED DESCRIPTION

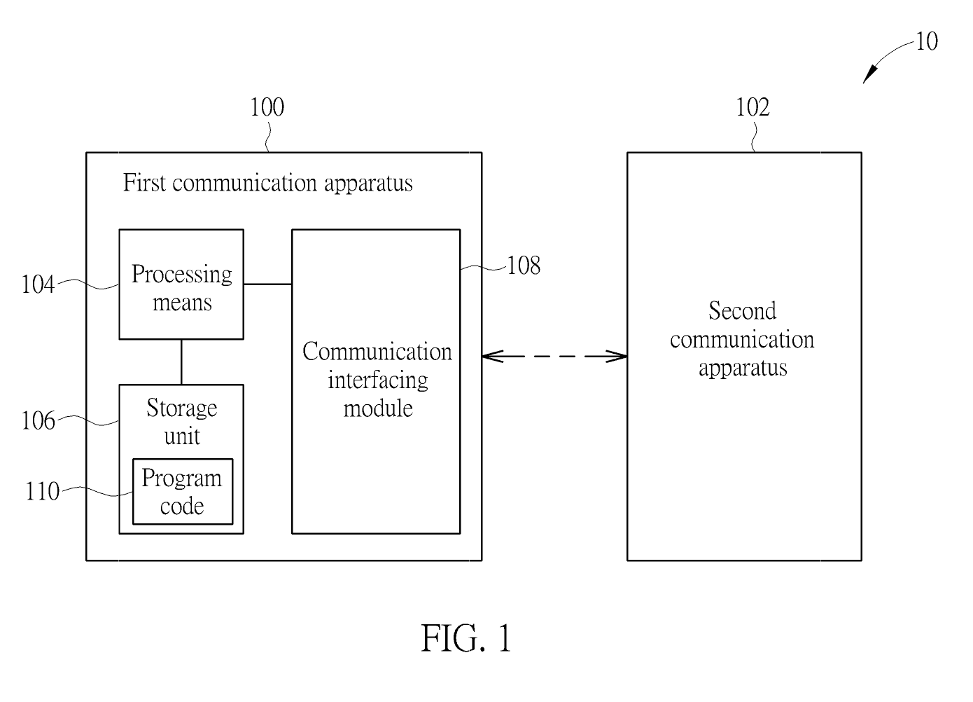

Please refer to FIG. 1, which is a schematic diagram of a wireless communications system 10 according to an example of the present invention. The wireless communications system 10 comprises a first communication apparatus 100 and a second communication apparatus 102. The first communication apparatus 100 and the second communication apparatus 102 are simply utilized for illustrating the structure of the wireless communications system 10. Practically, the first communication apparatus 100 and the second communication apparatus 102 can communicate with each other by a wireless technique, such as Wireless Fidelity (Wi-Fi) or Bluetooth. For example, in a Wi-Fi system, the first communication apparatus 100 may be a source device and the second communication apparatus 102 may be a sink device. Besides, the first communication apparatus 100 may include a processing means 104 such as a microprocessor or Application Specific Integrated Circuit (ASIC), a storage unit 106 and a communication interfacing module 108. The storage unit 106 may be any data storage device that can store a program code 110, accessed and executed by the processing means 104. Examples of the storage unit 106 include but are not limited to read-only memory (ROM), flash memory, random-access memory (RAM), CD-ROM/DVD-ROM, magnetic tape, hard disk and optical data storage device. The communication interfacing module 108 is preferably a transceiver and is used to transmit and receive signals (e.g., messages or packets) according to processing results of the processing means 104.

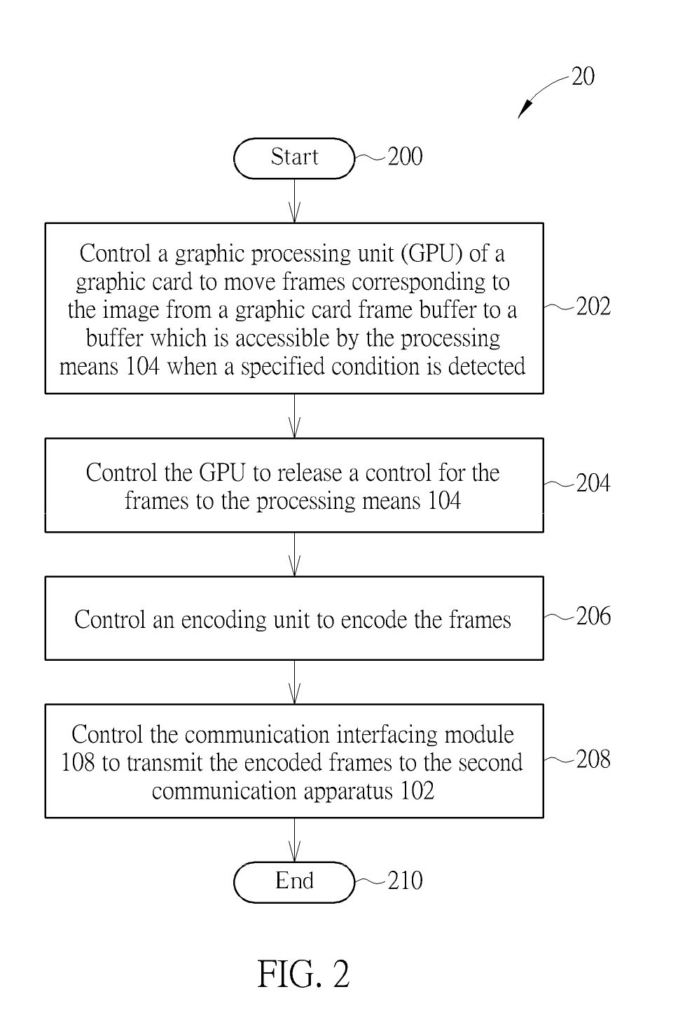

Please refer to FIG. 2, which is a flowchart of a process 20 according to an example of the present invention. The process 20 is utilized in the wireless communications system 10 shown in FIG. 1, for capturing an image. The process 20 can be utilized in the first communication apparatus 100, such as a source device, and may be compiled into the program code 110. The process 20 includes the following steps:

Step 200: Start.

Step 202: Control a graphic processing unit (GPU) of a graphic card to move frames corresponding to the image from a graphic card frame buffer to a buffer which is accessible by the processing means 104 when a specified condition is detected.

Step 204: Control the GPU to release a control for the frames to the processing means 104.

Step 206: Control an encoding unit to encode the frames.

Step 208: Control the communication interfacing module 108 to transmit the encoded frames to the second communication apparatus 102.

Step 210: End.

According to the process 20, the first communication apparatus 100 controls the GPU to move the frames to the buffer which can be accessible by the processing means 104 and release the control for the frames to the processing means 104, so that the processing means 104 can take replace of the GPU to perform relevant operations for the frames in the application layer. Therefore, the speed of display operation in the second communication apparatus 102 is increased.

In Steps 202 and 204, the first communication apparatus 100 may use an application programming interface with a graphic programming language to access the GPU graphic card and control the GPU to move the frames to the buffer which can be accessible by the processing means 104 and release the control for the frames to the processing means 104, wherein the graphic card may be externally connected to the first communication apparatus 100. Besides, in Step 206, since the GPU releases a control for the frames to the processing means 104, the processing means 104 can control the following operations for the frames, such as encoding operation. In Step 208, the first communication apparatus 100 transmits the encoded frames to the second communication apparatus 102 via the communication interfacing module 108, so that the second communication apparatus 102 can display the image.

In brief, since the processing means 104 cannot directly access the graphic card frame buffer, the processing means 104 is allowed to handle the frames via the moving and releasing operations of the GPU. Therefore, the first communication apparatus 100 performs relevant operations for the frames in the application layer so as to speed up the display operations of the second communication apparatus 102.

Note that, the process 20 is an example of the present invention, and those skilled in the art should readily make combinations, modifications and/or alterations on the abovementioned description and examples. For example, the application programming interface may be any programming interface capable of accessing the graphic card, such as Microsoft DirectX 11 or its updated version. The graphic programming language may be high level shader language (HLSL). Besides, the encoding unit is included in the first communication apparatus 100 and may be Intel H.264 encoder. In addition, the specified condition may be that the image changes or the image displays over a specific time. The specific time may be a pre-defined value. In other words, when the image being shown in a display of the first communication apparatus 100 or the second communication apparatus 102 is changed or the displaying operation of the image lasts over the specific time, the processing means 104 starts to control the GPU to move the frames from the graphic card frame buffer to the buffer which is accessible by the processing means 104 and follows to handle the frames. In another aspect, the graphic card frame buffer and the buffer which is accessible by the processing means 104 may be two independent memories, i.e. the graphic card frame buffer is allocated in the graphic card and the buffer which is accessible by the processing means 104 is allocated in the first communication apparatus 100. The graphic card frame buffer and the buffer which is accessible by the processing means 104 may also share the same memory in the first communication apparatus 100, but not limited herein.

In the present invention, the first communication apparatus controls the GPU to move the frames to the buffer which can be accessible by the processing means and release the control for the frames to the processing means. In other words, the first communication apparatus is allowed to handle the frames in the application layer due to the moving and releasing operations of the GPU, so that the speed of display operation in the second communication apparatus is increased.

To sum up, the present invention provides a method and an apparatus for capturing image, to enhance the display performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for capturing an image in a transmitter of a wireless communications system, the method comprising:
a central processing unit (CPU) of the transmitter controlling a graphic processing unit (GPU) of a graphic card to move frames corresponding to the image from a graphic card frame buffer to a memory which is accessible by the CPU; wherein the CPU is not located in the graphic card, and the memory which is accessible by the CPU is located in the transmitter and the memory is not located in the graphic card, and the frames of the image are moved by the GPU from the graphic card frame buffer to the memory after a displaying operation of the image;
controlling the GPU to release a control for the frames to the CPU;
encoding the frames in the memory which is accessible by the CPU; and
transmitting the encoded frames to a receiver of the wireless communications system;
wherein the graphic card is connected to the transmitter.

2. The method of claim 1, wherein the frames of the image are moved by the GPU from the graphic card frame buffer to the memory when the image displays over a specific time or the image changes.

3. The method of claim 1, wherein the step of controlling the GPU of the graphic card to move the frames corresponding to the image from the graphic card frame buffer to the memory which is accessible by the CPU comprises using an application programming interface with a graphic programming language to control and access the GPU.

4. The method of claim 3, wherein the graphic programming language is high level shader language (HLSL).

5. The method of claim 1, wherein controlling the GPU to release the control for the frames to the CPU such that the CPU obtains location information of the frames in the memory.

6. A communication apparatus for a wireless communications system, comprising:
a processor;
a storage device; and
a program code, stored in the storage device, wherein the program code instructs the processor to execute the following steps:
controlling a graphic processing unit (GPU) of a graphic card to move frames corresponding to the image from a graphic card frame buffer to a memory which is accessible by the processor, wherein the processor is not located in the graphic card, and the memory which is accessible by the processor is located in the communication apparatus and the memory is not located in the graphic card, and the frames of the image are moved by the GPU from the graphic card frame buffer to the memory after a displaying operation of the image;
controlling the GPU to release a control for the frames to the processor;
controlling an encoder to encode the frames in the memory which is accessible by the processor; and
controlling a transceiver to transmit the encoded frames to a receiver of the wireless communications system;
wherein the graphic card is connected to the communication apparatus.

7. The communication apparatus of claim 6, wherein the frames of the image are moved by GPU from the graphic card frame buffer to the memory when the image displays over a specific time or the image changes.

8. The communication apparatus of claim 6, wherein the step of controlling the GPU of the graphic card to move the frames corresponding to the image from the graphic card frame buffer to the memory which is accessible by the processor comprises using an application programming interface with a graphic programming language to control and access the GPU.

9. The communication apparatus of claim 8, wherein the graphic programming language is high level shader language (HLSL).

10. The communication apparatus of claim 6, controlling the GPU to release the control for the frames to the processor such that the processor obtains location information of the frames in the memory.

11. A method for capturing video content in a transmitter of a wireless communications system, the method comprising:
a central processing unit (CPU) of the transmitter controlling a graphic processing unit (GPU) to move video content from a frame buffer to a memory which is accessible by the CPU;
wherein the memory is located in the transmitter, the video content is displayed in the transmitter;
controlling the GPU to release a control for the video content to the CPU;
encoding the video content in the buffer which is accessible by the CPU; and
transmitting the encoded video content to the receiver of the wireless communications system.

12. The method of claim 11, wherein the GPU is located in a graphic card, and the CPU is not located in the graphic card, and the graphic card is connected to the transmitter.

13. The method of claim 11, wherein controlling the GPU to release the control for the video content to the CPU such that the CPU obtains location information of the video content in the memory.
